(19) United States
(12) Patent Application Publication
(10) Pub. No.: US 2023/0356153 A1
(43) Pub. Date: Nov. 9, 2023

(54) MEMBRANE HEAT TREATMENT METHOD

(71) Applicant: NGK INSULATORS, LTD., Nagoya-City (JP)

(72) Inventors: Aya MIURA, Kariya-City (JP); Narumi TOMOKAGE, Nagoya-City (JP); Azumi OTA, Nagoya-City (JP); Katsuya SHIMIZU, Owariasahi-City (JP)

(73) Assignee: NGK INSULATORS, LTD., Nagoya-City (JP)

(21) Appl. No.: 18/352,377

(22) Filed: Jul. 14, 2023

Related U.S. Application Data
(63) Continuation of application No. PCT/JP2022/002828, filed on Jan. 26, 2022.

(30) Foreign Application Priority Data
Jan. 28, 2021 (JP) 2021-011579

(51) Int. Cl. B01D 65/02; B01D 71/02; B01D 69/02

(52) U.S. Cl. CPC B01D 65/02; B01D 71/0281; B01D 69/02; B01D 2325/12; B01D 2323/081; B01D 2321/32

(57) ABSTRACT

A membrane heat treatment method includes a process of raising the temperature of a membrane to an intermediate heating temperature (step S21), a process of heating and keeping the membrane at the intermediate heating temperature (step S22), a process of raising the temperature of the membrane to a main heating temperature higher than the intermediate heating temperature (step S23), and the process of heating and keeping the membrane at the main heating temperature (step S24). A first recovery amount R1 that is a difference in permeability of the membrane between after step S22 and before step S21 is 50% or more and 95% or less of a second recovery amount R2 that is a difference in permeability of the membrane between after step S24 and before step S21.

### CROSS-REFERENCE TO RELATED APPLICATION

The present application is a continuation application of International Application No. PCT/JP2022/002828 filed on Jan. 26, 2022, which claims the benefit of priority to Japanese Patent Application No. 2021-11579 filed on Jan. 28, 2021. The entire contents of these applications are incorporated herein by reference.

### TECHNICAL FIELD

The present invention relates to a membrane heat treatment method for heating a membrane having small pores with adsorbates adsorbed therein.

### BACKGROUND ART

Various studies and developments have been currently conducted on the isolation of specific molecules via a separation membrane such as a zeolite membrane. For example, a separation apparatus is known for supplying a mixed gas that contains a plurality of substances to a zeolite membrane and isolating a substance having high permeability from the mixed gas by causing the substance to permeate through small pores of the zeolite membrane.

In the case where the separation apparatus uses a zeolite membrane that has been stored in the atmosphere, separation performance of the zeolite membrane may degrade due to adsorptive molecules in the atmosphere being adsorbed in small pores of the stored zeolite membrane and clogging the small pores. In the separation apparatus, the separation performance of the zeolite membrane may also degrade due to adsorptive molecules in the mixed gas being adsorbed in the small pores of the zeolite membrane and clogging the small pores.

The separation membrane with degraded separation performance needs to be subjected to heat treatment in order to remove substances adsorbed in the small pores (i.e., adsorbates) and thereby to recover the separation performance. For example, Japanese Patent Application Laid-Open No. 2016-175063 (Document 1) discloses a technique for performing heat treatment on a DDR-type zeolite membrane used in processing for separating a fluid mixture, by heating the zeolite membrane to a predetermined temperature (100° C. to 500° C.) at a predetermined rate of temperature rise and keeping the zeolite membrane at the predetermined temperature for a predetermined retention time (1 hour to 50 hours). Japanese Patent No. 6325450 (Document 2) discloses a technique for performing heat treatment on a zeolite membrane that has been exposed to water or an atmosphere with a humidity of 10% to 90% by heating the zeolite membrane in the atmosphere at a temperature lower than the oxidative pyrolysis temperature of a structure-directing agent used to deposit the zeolite membrane.

International Publication No. 2018/180210 (Document 3) discloses a technique for performing heat treatment on a zeolite membrane used in processing for separating a hydrocarbon mixture, by heating the zeolite membrane in an inert gas atmosphere. Japanese Patent Application Laid-Open No. 2013-34969 (Document 4) discloses a technique for performing heat treatment on a water separation membrane in a dehydration system for separating water from a processed fluid, by supplying a hot gas such as a nitrogen gas to the water separation membrane and causing the hot gas to permeate through the water separation membrane.

In the case where substances (i.e., adsorbates) adsorbed in small pores of the separation membrane are organic compounds, caulking may occur due to the adsorbates reacting (carbonizing) in the small pores and adhering to the small pores. If the heat treatment is performed at such a lower temperature that does not cause any reaction of the adsorbates in order to prevent the occurrence of caulking, the time required to remove the adsorbates by heating (i.e., the time required for the heat treatment) becomes longer. Besides, such a low-temperature heat treatment may result in insufficient recovery of performance of the separation membrane due to the incapability of sufficiently removing the adsorbates from the inside of the small pores.

In the aforementioned heat treatment, the adhesion of organic compounds in the small pores may be accelerated by catalytic reactions of the zeolite. Moreover, if the concentration of oxygen in the small pores is high, the amount of heat to be generated by oxidation reactions (i.e., combustion reactions) of the organic compounds may increase and cause damage to the separation membrane due to a local temperature rise.

### SUMMARY OF THE INVENTION

The present invention is intended for a membrane heat treatment method for heating a membrane having small pores with adsorbates adsorbed therein, and it is an object of the present invention to remove the adsorbates while reducing the occurrence of caulking and preventing damage to the membrane.

A membrane heat treatment method according to one embodiment of the present invention is a membrane heat treatment method for heating a membrane having small pores with adsorbates adsorbed therein. The membrane heat treatment method includes a) raising a temperature of the membrane to an intermediate heating temperature, b) heating and keeping the membrane at the intermediate heating temperature for a predetermined period of time, c) raising the temperature of the membrane to a main heating temperature that is higher than the intermediate heating temperature, and d) heating and keeping the membrane at the main heating temperature for a predetermined period of time. A first recovery amount that is a difference in permeability of the membrane between after the operation b) and before the operation a) is 50% or more and 95% or less of a second recovery amount that is a difference in permeability of the membrane between after the operation d) and before the operation a).

According to the present invention, it is possible to remove the adsorbates while reducing the occurrence of caulking and preventing damage to the membrane.

Preferably, the permeability of the membrane after (n+1) times repetitions of degradation of the permeability of the membrane and the operations a) to d) is 95% or more of the permeability of the membrane after n times repetitions of degradation of the permeability of the membrane and the operations a) to d), where n is an integer greater than or equal to 1 and less than or equal to 2000.

Preferably, the intermediate heating temperature is higher than or equal to 60° C. and lower than or equal to 180° C.

Preferably, the main heating temperature is higher than or equal to 150° C. and lower than or equal to 450° C.

Preferably, the membrane is a zeolite membrane.

Preferably, the zeolite membrane is composed of a maximum 8-membered ring zeolite.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a sectional view of a separation membrane complex according to one embodiment.

FIG. 2 is a sectional view showing part of the separation membrane complex in enlarged dimensions.

FIG. 3 is a diagram showing a separation apparatus.

FIG. 4 is a flowchart showing separation of a mixture of substances.

FIG. 5 is a flowchart of a membrane heat treatment method.

FIG. 6 is a diagram showing a change in the temperature of a separation membrane in the membrane heat treatment method.

FIG. 7 is a graph showing how permeability of the separation membrane is recovered by the membrane heat treatment method.

FIG. 8 is a graph showing how the permeability of the separation membrane is recovered by the membrane heat treatment method.

FIG. 9 is a diagram showing a change in the temperature of the separation membrane in the membrane heat treatment method.

### DESCRIPTION OF EMBODIMENTS

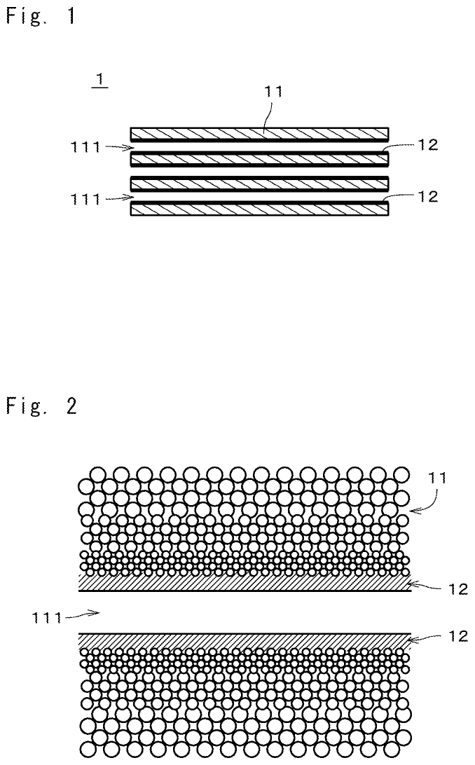

FIG. 1 is a sectional view of a separation membrane complex 1 according to one embodiment of the present invention. FIG. 2 is a sectional view showing part of the separation membrane complex 1 in enlarged dimensions. The separation membrane complex 1 includes a support 11 and a separation membrane 12. In FIG. 1, the separation membrane 12 is illustrated with thick lines. In FIG. 2, the separation membrane 12 is hatched, and the thickness of the separation membrane 12 is illustrated greater than the actual thickness of the separation membrane.

The support 11 is a porous member that is permeable to gas and liquid. In the example illustrated in FIG. 1, the support 11 is an integrally-molded approximately-column-like member. The support 11 has a plurality of through holes 111 each extending in the longitudinal direction of the support. That is, the support 11 is a so-called monolith member. The outside shape of the support 11 may, for example, be an approximately column-like shape. Each through hole 111 (i.e., cell) may have an approximately circular section that is perpendicular to the longitudinal direction. In FIG. 1, the diameter of the through holes 111 is illustrated greater than the actual diameter of the through holes, and the number of through holes 111 is illustrated smaller than the actual number of through holes.

The length of the support 11 (i.e., the length in the right-left direction in FIG. 1) may be in the range of, for example, 10 cm to 200 cm. The outside diameter of the support 11 may be in the range of, for example, 0.5 cm to 30 cm. A distance between the central axes of each pair of adjacent through holes 111 may be in the range of, for example, 0.3 mm to 10 mm. The surface roughness (Ra) of the support 11 may be in the range of, for example, 0.1 μm to 5.0 μm and preferably in the range of 0.2 μm to 2.0 μm. Note that the support 11 may have any other shape such as a honeycomb shape, a flat plate-like shape, a tube-like shape, a cylinder-like shape, a column-like shape, or a prism shape. In the case where the support 11 has a tube- or cylinder-like shape, the support 11 may have a thickness of, for example, 0.1 mm to 10 mm.

The material for the support 11 may be any of various substances (e.g., ceramic or metal) as long as the substance has chemical stability during the process of forming the separation membrane 12 on the surface. In the present embodiment, the support 11 is formed of a ceramic sintered body. Examples of the ceramic sintered body selected as the material for the support 11 include alumina, silica, mullite, zirconia, titania, yttria, silicon nitride, and silicon carbide. In the present embodiment, the support 11 contains at least one type of substances selected from among the group consisting of alumina, silica, and mullite.

The support 11 may contain an inorganic binding material. The inorganic binding material may, for example, be at least one selected from the group consisting of titania, mullite, easily sinterable alumina, sinterable alumina, silica, glass frit, clay minerals, and easily sinterable cordierite.

The support 11 may have a mean pore diameter of, for example, 0.01 μm to 70 μm and preferably 0.05 μm to 25 μm. The mean pore diameter of the support 11 in the vicinity of the surface on which the separation membrane 12 is formed may be in the range of 0.01 μm to 1 μm and preferably in the range of 0.05 μm to 0.5 The mean pore diameter may be measured by, for example, a mercury porosimeter, a perm-porometer, or a nano-perm-porometer. Referring to the pore size distribution of the support 11 as a whole including the surface and the interior, D5 may be in the range of, for example, 0.01 μm to 50 μm. D50 may be in the range of, for example, 0.05 μm to 70 μm and D95 may be in the range of, for example, 0.1 μm to 2000 μm. The support 11 has a porosity of, for example, 20% to 60% in the vicinity of the surface on which the separation membrane 12 is formed.

For example, the support 11 may have a multilayer structure in which a plurality of layers having different mean pore diameters are laminated one above another in the thickness direction. The mean pore diameter and the sintered particle size in a surface layer that includes the surface on which the separation membrane 12 is formed are smaller than the mean pore diameter and the sintered particle size in layers other than the surface layer. The mean pore diameter in the surface layer of the support 11 may be in the range of, for example, 0.01 μm to 1 μm and preferably in the range of 0.05 μm to 0.5 μm. In the case where the support 11 has a multilayer structure, the material for each layer may be any of the substances described above. Then layers that configure the multilayer structure may be formed of the same material, or may be formed of different materials.

The separation membrane 12 is an approximately cylinder-like thin membrane provided approximately across the entire inside surfaces of the through holes 111 of the support 11. The separation membrane 12 is a dense porous membrane with micropores. The separation membrane 12 is capable of separating a specific gas from a mixed gas of a plurality of types of gases by using a molecular-sieving function.

The separation membrane 12 may, for example, be an inorganic membrane and is a zeolite membrane in the present embodiment. The zeolite membrane refers to at least a zeolite formed into a membrane on the surface of the support 11, and does not refer to zeolite particles that are merely dispersed in an organic membrane. As described above, the zeolite membrane can be used as a separation membrane for separating a specific substance from a mixture of substances. The zeolite membrane is less permeable to substances other than the specific substance. In other words, the permeance of the zeolite membrane to the other substances is lower than the permeance of the zeolite membrane to the aforementioned specific substance. Note that the zeolite membrane may contain two or more types of zeolites having different structures or compositions.

The thickness of the separation membrane 12 may be in the range of, for example, 0.05 μm to 30 μm, preferably in the range of 0.1 μm to 20 μm, and more preferably in the range of 0.5 μm to 10 μm. Increasing the thickness of the separation membrane 12 improves separation performance. Reducing the thickness of the separation membrane 12 increases permeance. The surface roughness (Ra) of the separation membrane 12 may, for example, be less than or equal to 5 μm, preferably less than or equal to 2 μm, more preferably less than or equal to 1 μm, and yet more preferably less than or equal to 0.5 μm.

The pore sizes of the zeolite crystals contained in the separation membrane 12 (hereinafter, also simply referred to as the “pore sizes in the separation membrane 12”) are greater than or equal to 0.2 nm and less than or equal to 0.8 nm, more preferably greater than or equal to 0.3 nm and less than or equal to 0.7 nm, and yet more preferably greater than or equal to 0.3 nm and less than or equal to 0.45 nm. In the case where the pore sizes in the separation membrane 12 are less than 0.2 nm, the amount of gas permeation through the separation membrane 12 may be reduced, and in the case where the pore sizes in the separation membrane 12 are greater than 0.8 nm, the separation membrane 12 may have insufficient gas selectivity. The pore sizes in the separation membrane 12 refer to the diameters (minor axes) of small pores in a direction approximately perpendicular to the maximum diameter of small pores in the zeolite crystals of the separation membrane 12 (i.e., major axes that take the maximum value for the distance between oxygen atoms). The pore sizes in the separation membrane 12 are smaller than the mean pore diameter in the surface of the support 11 on which the separation membrane 12 is formed.

In the case where the zeolite membrane 12 is composed of a maximum n-membered ring zeolite, the minor axis of an n-numbered ring pore is assumed to be the pore size of the zeolite membrane 12. In the case where the zeolite has a plurality of types of n-membered ring pores where n is the same number, the minor axis of n-membered ring pores that have a largest minor axis is assumed to be the pore size of the zeolite membrane 12. Note that the n-membered ring refers to a ring in which the number of oxygen atoms constituting the framework of a pore is n and each oxygen atom is bonded to a T atom described later to form a cyclic structure. The n-membered ring also refers to a ring that forms a through hole (channel), and does not refer to a ring that fails to form a through hole. The n-membered ring pore refers to a small pore formed of an n-membered ring. From the viewpoint of improving selectivity, the zeolite membrane 12 described above may preferably contain a maximum 8- or less-membered ring zeolite (e.g., 6- or 8-membered ring zeolite).

The pore sizes in the separation membrane 12, which is the zeolite membrane, are uniquely determined by the framework structure of the zeolite and obtained from values disclosed in “Database of Zeolite Structures” [online], by International Zeolite Association, Internet <URL:http://www.iza-structure.org/databases/>.

There are no particular limitations on the type of the zeolite of the zeolite membrane 12, and examples of the zeolite include AEI-, AEN-, AFN-, AFV-, AFX-, BEA-, CHA-, DDR-, EM-, ETL-, FAU-(X-type, Y-type), GIS-, IHW-, LEV-, LTA-, LTJ-, MEL-, MFI-, MOR-, PAU-, RHO-, SOD-, and SAT-type zeolites. In the case where the zeolite is an 8-membered ring zeolite, examples of the zeolite include AEI-, AFN-, AFV-, AFX-, CHA-, DDR-, ERI-, ETL-, GIS-,IHW-, LEV-, LTA-, LTJ-, RHO-, and SAT-type zeolites.

The zeolite of the zeolite membrane 12 may contain, for example, aluminum (Al) as T atoms (i.e., atoms located in the center of an oxygen tetrahedron (TO₄) constituting the zeolite). The zeolite of the separation membrane 12 may, for example, be a zeolite that contains only silicon (Si) as T atoms or that contains Si and Al as T atoms, an AlPO-type zeolite that contains Al and phosphorus (P) as T atoms, an SAPO-type zeolite that contains Si, Al, and P as T atoms, an MAPSO-type zeolite that contains magnesium (Mg), Si, Al, and P as T atoms, or a ZnAPSO-type zeolite that contains zinc (Zn), Si, Al, and P as T atoms. Some of the T atoms may be replaced by other elements.

The zeolite membrane 12 may contain, for example, Si. For example, the zeolite membrane 12 may contain any two or more of substances selected from among the group consisting of Si, Al, and P. The zeolite membrane 12 may contain alkali metal. The alkali metal may, for example, be sodium (Na) or potassium (K). In the case where the zeolite membrane 12 contains Si atoms and Al atoms, the Si/Al ratio in the zeolite membrane 12 may, for example, be higher than or equal to one and lower than or equal to a hundred thousand. The Si/Al ratio refers to the molar ratio of Si elements to Al elements contained in the zeolite membrane 12. The Si/Al ratio may preferably be higher than or equal to 5, more preferably higher than or equal to 20, and yet more preferably higher than or equal to 100. A higher Si/Al ratio is more preferable The Si/Al ratio in the zeolite membrane 12 can be adjusted by, for example, adjusting the compounding ratio of an Si source and an Al source in a starting material solution described later.

In the separation membrane complex 1, the separation membrane 12 may further include, in addition to the zeolite membrane, a membrane other than the zeolite membrane. Alternatively, the separation membrane 12 may be an inorganic membrane other than the zeolite membrane, or may be a membrane other than an inorganic membrane (e.g., organic membrane).

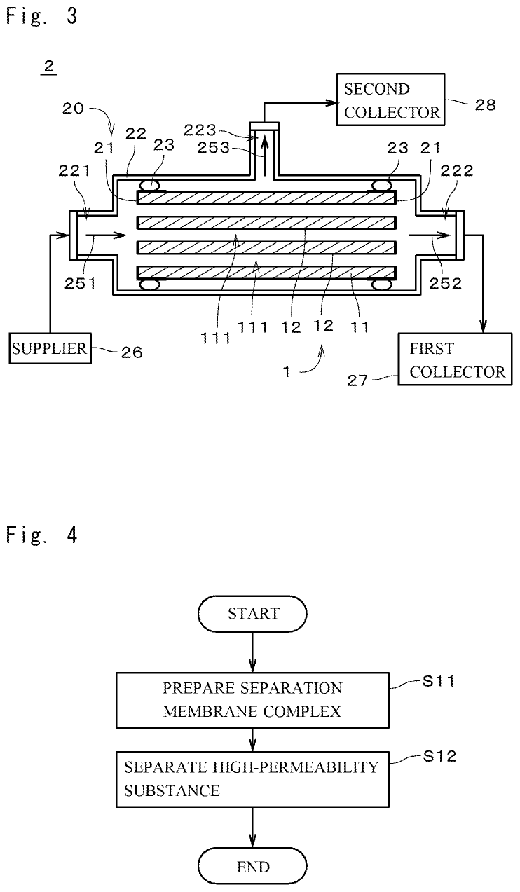

Next, the separation of a mixture of substances using the separation membrane complex 1 will be described with reference to FIGS. 3 and 4. FIG. 3 is a diagram showing a separation apparatus 2. FIG. 4 is a flowchart showing the separation of a mixture of substances by the separation apparatus 2.

The separation apparatus 2 supplies a mixture of substances that include a plurality of types of fluid (i.e., gas or liquid) to the separation membrane complex 1 and separates a substance having high permeability in the mixture of substances from the mixture of substances by causing the substance to permeate through the separation membrane complex 1. The separation apparatus 2 may conduct this separation for the purpose of extracting a substance with high permeability (hereinafter, also referred to as a “high-permeability substance”) from the mixture of substances or for the purpose of condensing a substance with low permeability (hereinafter, referred to as a “low-permeability substance”).

The mixture of substances (i.e., a fluid mixture) may be a mixed gas that includes a plurality of types of gas, may be a mixed solution that includes a plurality of types of liquid, or may be a gas-liquid two-phase fluid that includes both gas and liquid.

The mixture of substances may contain, for example, one or more types of substances selected from among the group consisting of hydrogen (H₂), helium (He), nitrogen (N₂), oxygen (O₂), water (H₂O), water vapor (H₂O), carbon monoxide (CO), carbon dioxide (CO₂), nitrogen oxides, ammonia (NH₃), sulfur oxides, hydrogen sulfide (H₂S), sulfur fluorides, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde. The aforementioned high-permeability substance may, for example, be one or more types of substances selected from among the group consisting of H₂, N₂, O₂, H₂O, Coe, and H₂S.

Nitrogen oxides are compounds of nitrogen and oxygen. For example, the aforementioned nitrogen oxides may be gas called NOₓ such as nitrogen monoxide (NO), nitrogen dioxide (NO₂), nitrous oxide (also referred to as dinitrogen monoxide) (N₂O), dinitrogen trioxide (N₂O₃), dinitrogen tetroxide (N₂O₄), or dinitrogen pentoxide (N₂O₅).

Sulfur oxides are compounds of sulfur and oxygen. For example, the aforementioned sulfur oxides may be gas called SO_{X} such as sulfur dioxide (SO₂) or sulfur trioxide (SO₃).

Sulfur fluorides are compounds of fluorine and sulfur. For example, the aforementioned sulfur fluorides may be disulfur difluoride (F—S—S—F, S═SF₂), sulfur difluoride (SF₂), sulfur tetrafluoride (SF₄), sulfur hexafluoride (SF₆), or disulfur decafluoride (S₂F₁₀).

C1 to C8 hydrocarbons are hydrocarbons that contain one or more and eight or less carbon atoms. C3 to C8 hydrocarbons each may be any of a linear-chain compound, a side-chain compound, and a cyclic compound. C2 to C8 hydrocarbons each may be either of a saturated hydrocarbon (i.e., where double bonds and triple bonds are not located in molecules) and an unsaturated hydrocarbon (i.e., where double bonds and/or triple bonds are located in molecules). C1 to C4 hydrocarbons may, for example, be methane (CH₄), ethane (C₂H₆), ethylene (C₂H₄), propane (C₃H₈), propylene (C₃H₆), normal butane (CH₃(CH₂)₂CH₃), isobutene (CH(CH₃)₃), 1-butene (CH₂═CHCH₂CH₃), 2-butene (CH₃CH═CHCH₃), or isobutene (CH₂═C(CH₃)₂).

The aforementioned organic acid may, for example, be carboxylic acid or sulfonic acid. The carboxylic acid may, for example, be formic acid (CH₂O₂), acetic acid (C₂H₄O₂), oxalic acid (C₂H₂O₄), acrylic acid (C₃H₄O₂), or benzoic acid (C₆H₅COOH). The sulfonic acid may, for example, be ethane sulfonic acid (C₂H₆O₃S). The organic acid may be a chain compound, or may be a cyclic compound.

The aforementioned alcohol may, for example, be methanol (CH₃OH), ethanol (C₂H₅OH), isopropanol (2-propanol) (CH₃CH(OH)CH₃), ethylene glycol (CH₂(OH)CH₂(OH)), or butanol (C₄H₉OH).

Mercaptans are organic compounds with terminal sulfur hydrides (SH) and also are substances called thiol or thioalcohol. The aforementioned mercaptans may, for example, be methyl mercaptan (CH₃SH), ethyl mercaptan (C₂H₅SH), or 1-propane thiol (C₃H₇SH).

The aforementioned ester may, for example, be formic acid ester or acetic acid ester.

The aforementioned ether may, for example, be dimethyl ether ((CH₃)₂O), methyl ethyl ether (C₂H₅OCH₃), or diethyl ether ((C₂H₅)₂O).

The aforementioned ketone may, for example, be acetone ((CH₃)₂CO), methyl ethyl ketone (C₂H₅COCH₃), or diethyl ketone ((C₂H₅)₂CO).

The aforementioned aldehyde may, for example, be acetaldehyde (CH₃CHO), propionaldehyde (C₂H₅CHO), or butanal (butyraldehyde) (C₃H₇CHO).

The following description is given on the assumption that a mixture of substances to be separated by the separation apparatus 2 is a mixed gas that includes a plurality of types of gas.

The separation apparatus 2 includes the separation membrane complex 1, a sealer 21, an outer cylinder 22, two seal members 23, a supplier 26, a first collector 27, and a second collector 28. The separation membrane complex 1, the sealer 21, and the seal members 23 are placed in the outer cylinder 22. The supplier 26, the first collector 27, and the second collector 28 are arranged outside the outer cylinder 22 and connected to the outer cylinder 22.

The sealer 21 is a member that is attached to both ends of the support 11 in the longitudinal direction (i.e., the left-right direction in FIG. 3) to cover and seal both end faces of the support 11 in the longitudinal direction and the outside surface of the support 11 in the vicinity of the both end faces. The sealer 21 prevents inflow and outflow of gas and liquid from the both end faces of the support 11. For example, the sealer 21 may be a plate-like or membranous member formed of glass or resin. The material and shape of the sealer 21 may be appropriately changed. Note that the sealer 21 has a plurality of openings that overlap with the plurality of through holes 111 of the support 11, so that both ends of each through hole 111 of the support 11 in the longitudinal direction are not covered with the sealer 21. This allows the inflow and outflow of gas and fluid from the both ends of each through hole 111 into and out of the through hole.

There are no particular limitations on the shape of the outer cylinder 22, and the outer cylinder 22 may, for example, be an approximately cylinder-like tubular member. For example, the outer cylinder 22 may be formed of stainless steel or carbon steel. The longitudinal direction of the outer cylinder 22 is approximately parallel to the longitudinal direction of the separation membrane complex 1. One end of the outer cylinder 22 in the longitudinal direction (i.e., the end on the left side in FIG. 3) is provided with a supply port 221, and the other end thereof is provided with a first exhaust port 222. The side face of the outer cylinder 22 is provided with a second exhaust port 223. The supply port 221 is connected to the supplier 26. The first exhaust port 222 is connected to the first collector 27. The second exhaust port 223 is connected to the second collector 28. The internal space of the outer cylinder 22 is an enclosed space isolated from the space around the outer cylinder 22.

The two seal members 23 are arranged around the entire circumference between the outside surface of the separation membrane complex 1 and the inside surface of the outer cylinder 22 in the vicinity of the both ends of the separation membrane complex 1 in the longitudinal direction. Each seal member 23 is an approximately ring-shaped member formed of a material that is impermeable to gas and liquid. For example, the seal members 23 may be O-rings formed of resin having flexibility. The seal members 23 are in tight contact with the outside surface of the separation membrane complex 1 and the inside surface of the outer cylinder 22 along the entire circumference. In the example illustrated in FIG. 3, the seal members 23 are in tight contact with the outside surface of the sealer 21 and are in indirect tight contact with the outside surface of the separation membrane complex 1 via the sealer 21. A space between the seal members 23 and the outside surface of the separation membrane complex 1 and a space between the seal members 23 and the inside surface of the outer cylinder 22 are sealed so as to almost or completely disable the passage of gas and liquid.

The supplier 26 supplies the mixed gas to the internal space of the outer cylinder 22 via the supply port 221. The supplier 26 may include, for example, a pressure mechanism such as a blower or pump that pumps the mixed gas toward the outer cylinder 22. The pressure mechanism may include, for example, a temperature regulator and a pressure regulator that respectively control the temperature and pressure of the mixed gas to be supplied to the outer cylinder 22. The first collector 27 and the second collector 28 may include, for example, a reservoir that stores the gas delivered from the outer cylinder 22, or a blower or a pump that transfers this gas.

In the separation of the mixed gas, first, the separation membrane complex 1 is prepared (step S11 in FIG. 4). Specifically, the separation membrane complex 1 is mounted on the inside of the outer cylinder 22. Then, the mixed gas including a plurality of types of gas to which the zeolite membrane 12 has different permeability is supplied from the supplier 26 to the inside of the outer cylinder 22 as indicated by an arrow 251. The mixed gas may be composed primarily of, for example, CO₂ and CH₄. The mixed gas may also include a gas other than CO₂ and CH₄. The pressure of the mixed gas supplied from the supplier 26 to the inside of the outer cylinder 22 (i.e., feed pressure that is primary gas pressure of the separation membrane 12) may be in the range of, for example, 0.1 MPaG to 20.0 MPaG. The temperature of the mixed gas supplied from the supplier 26 may be in the range of, for example, 10° C. to 250° C.

The mixed gas supplied from the supplier 26 to the outer cylinder 22 is introduced from the left end of the separating membrane complex 1 in the drawing into each through hole 111 of the support 11 (i.e., to the inside of the approximately cylinder-like isolation membrane 12). A high-permeability gas, which is a gas with high permeability in the mixed gas, is guided from the outside surface of the support 11 through the separation membrane 12 provided on the inside surface of each through hole 111 and the support 11. Accordingly, the high-permeability gas (e.g., CO₂) is separated from a low-permeability gas (e.g., CH₄), which a gas with low permeability in the mixed gas (step S12).

The gas derived from the outside surface of the support 11 (hereinafter, also referred to as the “permeation gas”) is guided to the second collector 28 via the second exhaust port 223 as indicated by an arrow 253 and collected by the second collector 28. The pressure of the gas collected by the second collector 28 (i.e., permeate pressure that is secondary gas pressure of the separation membrane 12) may, for example, be 0.0 MPaG. In other words, the difference between the feed pressure and the permeate pressure may be in the range of, for example, 0.1 MPa to 20.0 MPa. The permeation gas may further include, in addition to the aforementioned high-permeability gas, a low-permeability gas that has permeated through the separation membrane 12.

In the mixed gas, a gas that excludes the gas having permeated through the separation membrane 12 and the support 11 (hereinafter, also referred to as a “non-permeated gas”) passes through each through hole 111 of the support 11 from the left side to the right side in the drawing and collected by the first collector 27 via the first exhaust port 222 as indicated by an arrow 252. The pressure of the gas collected by the first collector 27 may, for example, be approximately the same as the feed pressure. The non-permeated gas may further include, in addition to the aforementioned low-permeability gas, a high-permeability gas that has not permeated through the separation membrane 12. For example, the non-permeated gas collected by the first collector 27 may be circulated by the supplier 26 and supplied again to the inside of the outer cylinder 22.

In the separation membrane complex 1 described above, substances contained in the atmosphere may be adsorbed in small pores of the separation membrane 12 during storage in the atmosphere. Substances adsorbed in small pores of the separation membrane 12 (i.e., adsorbates) may, for example, be H₂O and/or volatile organic compounds contained in the atmosphere. The adsorbates of the volatile organic compounds may, for example, be hydrocarbon containing three or more carbon (C) atoms. Examples of the adsorbates of the volatile organic compounds include acetone, isopropyl alcohol, methyl ethyl ketone, ethyl acetate, n-butanol, methyl isobutyl ketone, butyl acetate, toluene, m-xylene, p-xylene, o-xylene, 1,3,5-trimethyl benzene, decane, n-butane, isobutane, n-hexane, n-pentane, cis-2-butene, and undecane. In the separation membrane complex 1, substances contained in the mixed gas may also be adsorbed in small pores of the separation membrane 12 during use in separating the mixed gas in the separation apparatus 2.

If the adsorbates are adsorbed in small pores of the separation membrane 12 in this way, the small pores may be clogged with the adsorbates, and the separation membrane 12 may have degraded permeability. In view of this, membrane heat treatment is performed in which the adsorbates are removed (i.e., eliminated) from the inside of the small pores of the separation membrane 12 in order to recover the permeability of the separation membrane 12.

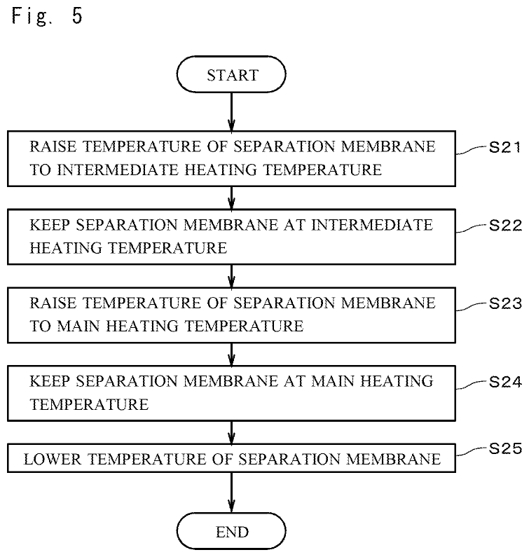

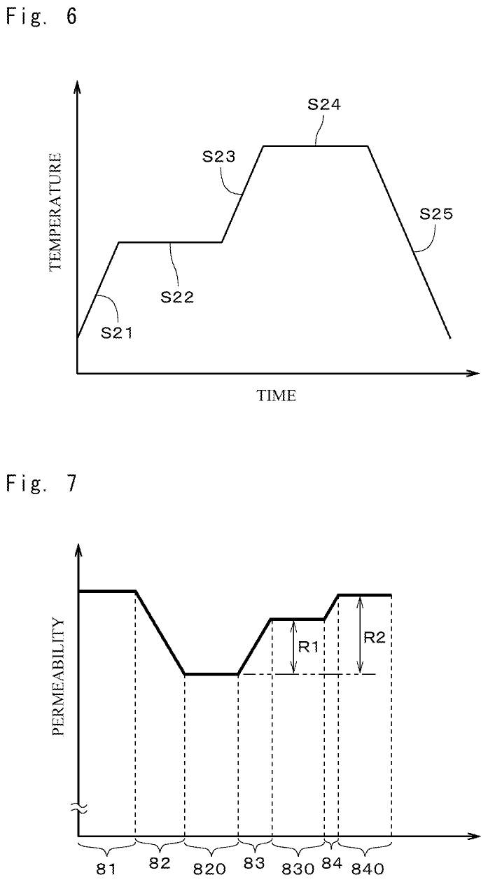

FIG. 5 is a flowchart of a membrane heat treatment method for heating the separation membrane 12 having small pores with adsorbates adsorbed therein. FIG. 6 shows a change in the temperature of the separation membrane 12 (i.e., a temperature profile) by the membrane heat treatment method. In FIG. 6, reference signs S21 to S25 are assigned to regions that correspond respectively to steps S21 to S25 in FIG. 5.

In the membrane heat treatment method, first, the separation membrane complex 1 is set in a heater. For example, the separation membrane complex 1 is detached from the outer cylinder 22 of the separation apparatus 2 and placed in the heater such as a drier. The heater may be any of various devices other than the drier as long as the device is capable of heating the separation membrane complex 1 to a desired temperature described later.

When the separation membrane complex 1 is set in the heater, the atmosphere inside the heater is set to a desired atmosphere (hereinafter, also referred to as a “heat-treatment atmosphere”). The heat-treatment atmosphere may, for example, be a low oxygen atmosphere having a lower oxygen concentration than in ambient atmosphere. The oxygen concentration in the heat-treatment atmosphere may, for example, be 10% or less by volume and preferably 5% or less by volume. This atmosphere reduces the occurrence of sudden combustion reactions of the adsorbates during heating of the separation membrane complex 1, which will be described later, and prevents damage to the separation membrane 12 due to a local and sudden temperature rise.

In the heater, the low oxygen atmosphere is produced by, for example, supplying an inert gas such as nitrogen (N₂) to the inside of the heater. Alternatively, carbon dioxide (CO₂) may be supplied to the inside of the heater. The gas supplied to the inside of the heater may preferably be the aforementioned high-permeability substance that can easily permeate the separation membrane 12. Accordingly, it is possible to prevent or reduce the possibility that the small pores of the separation membrane 12 are clogged with substances contained in the heat-treatment atmosphere. It is also possible to uniformly heat the separation membrane 12 because the heated atmosphere can easily permeate through the small pores of the separation membrane 12 during heating of the separation membrane complex 1, which will be described later. Moreover, since N₂ or CO₂ is used as the gas to be supplied to the heater, it is possible to reduce the cost required for the membrane heat treatment method. Note that the gas to be supplied to the heater as the heat-treatment atmosphere may be composed of only one kind of substance, or may be a mixed gas that contains a plurality of types of substances.

The heater may perform the following membrane heat treatment of the separation membrane 12 after the internal space of the heater in which the separation membrane complex 1 is placed is filled and sealed with the heat-treatment atmosphere described above, or may perform the membrane heat treatment while causing the heat-treatment atmosphere to flow into the internal space (i.e., continuously supplying the heat-treatment atmosphere). Depending on the flow of the heat-treatment atmosphere in the internal space of the heater, the membrane heat treatment may be performed in a state in which a differential pressure occurs between spaces on both sides that sandwich the separation membrane 12, and part of the heat-treatment atmosphere continuously permeates through the separation membrane 12. It is preferable that the interior of the heater may be maintained in the heat-treatment atmosphere until the membrane heat treatment is completed.

When the internal space provided for the heat treatment is set in the heat-treatment atmosphere described above, the heater heats the separation membrane complex 1 so as to raise the temperature of the separation membrane complex 1 (i.e., the support 11 and the separation membrane 12) from the ambient temperature (e.g., 20° C.) to a predetermined intermediate heating temperature (step S21: upstream temperature-rise process). The intermediate heating temperature may, for example, be higher than or equal to 60° C. and lower than or equal to 180° C., preferably higher than or equal to 70° C. and lower than or equal to 160° C., and more preferably higher than or equal to 80° C. and lower than or equal to 150° C. The intermediate heating temperature is appropriately set depending on the types of the adsorbates and the separation membrane 12. In the case where the zeolite of the separation membrane 12 functions as a catalyst that accelerates reactions of the adsorbates such as carbonization reactions, the intermediate heating temperature may, for example, be lower than the catalytic reaction temperature of the zeolite.

The rate of temperature rise in step S21 (hereinafter, also referred to as an “upstream temperature-rise rate”) may, for example, be higher than or equal to 5° C./h and preferably higher than or equal to 10° C./h. This avoids an increase in the temperature-rise time in step S21. There are no particular limitations on the upper limit for the rate of temperature rise in step S21, but from the viewpoint of reducing the occurrence of thermal stress on the separation membrane complex 1, the rate of temperature rise may, for example, be lower than or equal to 200° C./h and preferably lower than or equal to 100° C./h.

When the temperature of the separation membrane complex 1 has been raised to the intermediate heating temperature, the heater described above heats the separation membrane 12 for a predetermined period of time while maintaining the temperature of the separation membrane 12 at the intermediate heating temperature (step S22: intermediate heating process). In the following description, the heating time at the intermediate heating temperature in step S22 is also referred to as an “intermediate heating time.” The intermediate heating time may be in the range of, for example, 1 hour to 48 hours. By heating the separation membrane 12 in step S22, some of the adsorbates adsorbed in the small pores of the separation membrane 12 are eliminated from the surfaces of the small pores by heat and removed from the inside of the small pores. Accordingly, the permeability of the separation membrane 12 is recovered to a predetermined degree or more as will be described later.

The intermediate heating temperature and the intermediate heating time described above may be appropriately set according to conditions such as the type of adsorbates, adsorptive power of the adsorbates acting on the separation membrane 12, and the degree of degradation of the permeability of the separation membrane 12. For example, in the case where the adsorbates are highly reactive with the separation membrane 12 and easy to carbonize, the intermediate heating temperature may be set longer in order to reduce the occurrence of carbonization reactions of the adsorbates. For example, in the case where the adsorptive power of the adsorbates acting on the separation membrane 12 is relatively low and the degree of degradation of the permeability of the separation membrane 12 is also relatively low, the intermediate heating time may be set shorter so as to shorten the time required for the membrane heat treatment of the separation membrane 12.

Note that an excessively low intermediate heating temperature may result in an insufficient degree of recovery of the permeability of the separation membrane 12 at the end of step S22, or may require a long time to recover the permeability to a predetermined degree or more. Therefore, the intermediate heating temperature may, for example, be 60° C. or higher, preferably 70° C. or higher, and more preferably 80° C. or higher. On the other hand, an excessively high intermediate heating temperature may cause carbonization and adhesion of the adsorbates to the inside of the small pores of the separation membrane 12 in step S22 and result in the occurrence of caulking. Therefore, the intermediate heating temperature may, for example, be 180° C. or lower, preferably 160° C. or lower, and more preferably 150° C. or lower.

Moreover, an excessively long intermediate heating time is not suitable for practical membrane heat treatment and may cause the separation membrane 12 to become deformed due to thermal histories. Therefore, the intermediate heating time may, for example, be 48 hours or shorter, preferably 24 hours or shorter, and more preferably 16 hours or shorter. On the other hand, an excessively short intermediate heating time may result in an insufficient degree of recovery of the permeability of the separation membrane 12 at the end of step S22. Therefore, the intermediate heating time may, for example, be 1 hour or longer and preferably 2 house or longer.

In step S22, the temperature of the separation membrane 12 is preferably maintained at a fixed intermediate heating temperature in a strict sense, but it may vary to some degree (e.g., slightly fluctuate) in the vicinity of the intermediate heating temperature. Alternatively, in step S22, the temperature at the end of the intermediate heating process may become slightly higher or lower than the temperature at the start of the intermediate heating process, depending on variations in the temperature of the separation membrane 12. Both cases are included in the state in which the temperature of the separation membrane 12 is maintained at the intermediate heating temperature.

In the case where the temperature at the end of the intermediate heating process differs from the temperature at the start of the intermediate heating process in step S22, the value obtained by dividing the absolute value of a difference between the temperature at the end of the intermediate heating process and the temperature at the start of the intermediate heating process by the intermediate heating time is less than the rate of temperature rise (i.e., upstream temperature-rise rate) in step S21 and preferably 50% or less of the upstream temperature-rise rate. In this case, the value obtained by dividing the absolute value of the difference between the temperature at the end of the intermediate heating process and the temperature at the start of the intermediate heating process by the intermediate heating time is less than the rate of temperature rise in step S23, which will be described later (hereinafter, also referred to as a “downstream temperature-rise rate”), and preferably 50% or less of the downstream temperature-rise rate.

When the intermediate heating time has elapsed and step S22 (intermediate heating process) is completed, the heater described above heats the separation membrane 12 from the intermediate heating temperature to a predetermined main heating temperature (step S23: downstream temperature-rise process). The main heating temperature is higher than the intermediate heating temperature and may, for example, be higher than or equal to 150° C. and lower than or equal to 450° C., preferably higher than or equal to 160° C. and lower than or equal to 400° C., and more preferably higher than or equal to 160° C. and lower than or equal to 380° C. The main heating temperature is appropriately set depending on the types of the adsorbates and the separation membrane 12.

The rate of temperature rise in step S23 (hereinafter, also referred to as a “downstream temperature-rise rate”) may, for example, be 5° C./h or higher and preferably 10° C./h or higher. This avoids an increase in the temperature-rise time in step S23. There are no particular limitations on the upper limit for the rate of temperature rise in step S23, but from the viewpoint of reducing the occurrence of thermal stress on the separation membrane complex 1, the rate of temperature rise may, for example, be 200° C./h or lower and preferably 100° C./h or lower.

When the temperature of the separation membrane complex 1 has been raised to the main heating temperature, the temperature rise of the separation membrane 12 is stopped. Then, the heater described above heats the separation membrane 12 for a predetermined period of time while maintaining the temperature of the separation membrane 12 at the main heating temperature (step S24: main heating process). In the following description, the heating time at the main heating temperature in step S24 is also referred to as a “main heating time.” The main heating time may be in the range of, for example, 1 hour to 48 hours. By heating the separation membrane 12 in step S24, the adsorbates remaining in the small pores of the separation membrane 12 without removal are removed from the inside of the small pores. For example, in the case where the adsorbates are organic compounds, the adsorbates may be removed by oxidation. Accordingly, the permeability of the separation membrane 12 is recovered.

The main heating temperature and the main heating time described above may be appropriately set depending on conditions such as the type of the adsorbates, the adsorptive power of the adsorbates acting on the separation membrane 12, and the degree of degradation of the permeability of the separation membrane 12. For example, in the case where the adsorbates are highly reactive with the separation membrane 12 and easy to carbonize, the main heating temperature may be set low and the main heating time may be set long so as to reduce the occurrence of carbonization reactions of the adsorbates. For example, in the case where the adsorptive power of the adsorbates acting on the separation membrane 12 is relatively low and the degree of degradation of the permeability of the separation membrane 12 is also relatively low, the main heating time may be set short so as to shorten the time required for the membrane heat treatment of the separation membrane 12.

Note that an excessively low main heating temperature may cause the adsorbates to remain in large amounts in the small pores of the separation membrane 12, or may require a long time to remove the adsorbates. Therefore, the main heating temperature may, for example, be 150° C. or higher and preferably 160° C. or higher. On the other hand, an excessively high main heating temperature may cause damage to the separation membrane 12 due to thermal stress. Therefore, the main heating temperature may, for example, be 450° C. or lower, preferably 400° C. or lower, and more preferably 380° C. or lower.

Moreover, an excessively long main heating time is not suitable for practical membrane heat treatment and may cause the separation membrane 12 to become deformed due to thermal histories. Therefore, the main heating time may, for example, be 48 hours or shorter, preferably 24 hours or shorter, and more preferably 16 hours or shorter. On the other hand, an excessively short main heating time may result in an insufficient degree of recovery of the permeability of the separation membrane 12. Therefore, the main heating time may, for example, be 1 hour or longer and preferably two hours or longer.

In step S24, the temperature of the separation membrane 12 is preferably maintained constant at the main heating temperature in a strict sense, but it may vary to some degree (e.g., slightly fluctuate) in the vicinity of the main heating temperature. Alternatively, in step S24, the temperature at the end of the main heating process may become slightly higher or lower than the temperature at the start of the main heating process due to fluctuations in the temperature of the separation membrane 12. Both cases are included in the state in which the temperature of the separation membrane 12 is maintained at the main heating temperature.

In the case where the temperature at the end of the main heating process differs from the temperature at the start of the main heating process in step S24, the value obtained by dividing the absolute value of a difference between the temperature at the end of the main heating process and the temperature at the start of the main heating process by the main heating time is less than the upstream temperature-rise rate and may preferably be 50% or less of the upstream temperature-rise rate. In this case, the value obtained by dividing the absolute value of the difference between the temperature at the end of the main heating process and the temperature at the start of the main heating process by the main heating time may be less than the downstream temperature-rise rate and preferably 50% or less of the downstream temperature-rise rate.

When the main heating time has elapsed and step S24 (main heating process) is completed, the temperature of the separation membrane 12 is lowered from the main heating temperature (step S25: temperature fall process). In step S25, the temperature of the separation membrane 12 is lowered by, for example, controlling the rate of temperature fall by the heater described above.

Alternatively, the separation membrane 12 may be naturally cooled by taking the separation membrane complex 1 out of the heater and leaving the separation membrane complex 1 to stand in the atmosphere.

The rate of temperature fall in step S25 may, for example, be −5° C./h or lower and preferably −10° C./h or lower. This avoids an increase in the temperature fall time in step S25. There are no particular limitations on the lower limit for the rate of temperature fall in step S25, but the rate of temperature fall may, for example, be −200° C./h or higher and preferably −100° C./h or higher from the viewpoint of reducing the occurrence of thermal stress on the separation membrane complex 1.

The separation membrane complex 1 that has a lowered temperature and that has undergone the completion of the membrane heat treatment is attached again to the inside of the outer cylinder 22 of the separation apparatus 2. In the membrane heat treatment, the main heating temperature in step S24 is the maximum temperature during processing.

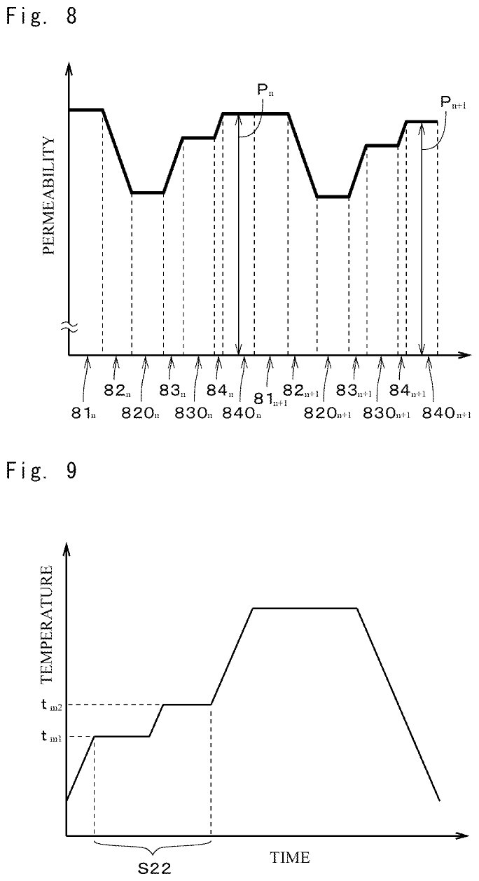

FIG. 7 is a graph schematically showing how the permeability of the separation membrane 12 is recovered by the membrane heat treatment method described above. In FIG. 7, the horizontal axis indicates the time course, and the vertical axis indicates the permeability of the separation membrane 12. The length of the horizontal axis is not proportional to the length of the actual elapsed time. The permeability in each region described later is indicated by the straight line, but the actual permeability may change in a curve. The same applies to FIG. 8 described later.

In the present embodiment, the permeability refers to N₂ permeance when a gas that contains N₂ is supplied to the separation membrane complex 1 under predetermined supply conditions in the separation apparatus 2. The permeance may be measured by, for example, supplying a gas that is substantially N₂ alone to the separation apparatus 2 under conditions including a feed temperature of 20° C. to 30° C., a feed pressure of 0.1 MPaG to 0.5 MPaG, and a permeate pressure of 0 MPaG to 0.1 MPaG. The permeance is obtained by measuring the permeation gas collected by the second collector 28 of the separation apparatus 2 with flow-rate measuring equipment such as a massflow meter (MFM). These measurement conditions including the feed temperature, the feed pressure, and the permeate pressure may be arbitrarily set, but the same conditions for measuring the permeance is used for each region described later. In the case where the membrane heat treatment described above is performed multiple times, the same conditions for measuring the permeance are used each time. Note that a gas other than N₂ (preferably, the high-permeability substance described above such as CO₂) may be supplied to the separation membrane complex 1, and the permeability of the separation membrane 12 may be evaluated based on the permeance of this gas.

Referring to the horizontal axis in FIG. 7, a region 81 indicates a period in which the permeability of the separation membrane 12 is maintained approximately constant. A region 82 indicates a period in which the adsorbates adsorbed in the small pores of the separation membrane 12 gradually increase in amounts and gradually degrade the permeability of the separation membrane 12 during storage or use of the separation membrane complex 1. Regions 83 and 84 indicate periods in which the membrane heat treatment described above is performed. The region 83 corresponds to step S21 (upstream temperature-rise process) and step S22 (intermediate heating process) described above. The region 84 corresponds to step S23 (downstream temperature-rise process) and step S24 (main heating process) described above.

A region 820 between the regions 82 and 83 is provided for the sake of convenience in order to facilitate understanding the boundary between the regions 82 and 83. A period that actually corresponds to the region 820 does not exist, and the region 820 corresponds to a state immediately before the start of step S21 (upstream temperature-rise process) in the membrane heat treatment. A region 830 between the regions 83 and 84 is provided for the sake of convenience in order to facilitate understanding of the boundary between the regions 83 and 84. A process that actually corresponds to the region 830 does not exist in the membrane heat treatment described above, and the region 830 corresponds to the state immediately after the end of step S22 (intermediate heating process). A region 840 following the region 84 is provided for the sake of convenience in order to facilitate understanding of the end point of the region 84. A process that actually corresponds to the region 840 does not exist in the membrane heat treatment described above, and the region 840 corresponds to a state immediately after the end of step S24 (main heating process). In the regions 820, 830, and 840, the permeability of the separation membrane 12 is illustrated as remaining constant.

In some cases, the periods that actually correspond to the regions 81 and 82 may be longer than the periods that actually correspond to the regions 83 and 84. The graph indicating the permeability in the region 82 is illustrated in an approximately straight line, but in actuality the permeability changes in various ways depending on the types of the adsorbates and the separation membrane 12. The same applies to the regions 83 and 84. Moreover, in FIG. 7, the inclination of the graph indicating the permeability in region 83 is illustrated to be approximately the same as the inclination of the graph indicating the permeability in the region 84, but these inclinations may be different.

In the following description, a value obtained by subtracting the permeability of the separation membrane 12 in the region 820 from the permeability of the separation membrane 12 in the region 830 in FIG. 7 is referred to as a “first recovery amount” and given a reference sign R1 in FIG. 7. Moreover, a value obtained by subtracting the permeability of the separation membrane 12 in the region 820 from the permeability of the separation membrane 12 in the region 840 is referred to as a “second recovery amount” and given a reference sign R2 in FIG. 7. That is, the first recovery amount R1 is a difference in permeability of the separation membrane 12 between after step S22 (intermediate heating process) and before step S21 (upstream temperature-rise process). The second recovery amount R2 is a difference in permeability of the separation membrane 12 between after step S24 (main heating process) and before step S21 (upstream temperature-rise process).

In the membrane heat treatment described above, the first recovery amount R1 is set to be 50% or more and 95% or less of the second recovery amount R2. In other words, R1/R2 (hereinafter, also referred to as a “post-intermediate-heating recovery rate”) is higher than or equal to 50% and lower than or equal to 95%. In the membrane heat treatment, the first recovery amount R1 is made to be 50% or more of the second recovery amount R2, primarily in step S22, by removing a relatively large amount of the adsorbates adsorbed in the small pores of the separation membrane 12 at the intermediate heating temperature, which is the relatively low temperature of a degree that substantially does not produce carbonization reactions of the adsorbates. Thus, there remains only small amounts of adsorbates to be removed from the inside of the small pores in step S24. Accordingly, in the case of removing the adsorbates at the relatively high main heating temperature, it is possible to speedily remove the remaining adsorbates almost completely or mostly while reducing the occurrence of caulking due to carbonization reactions of the adsorbates or any other reasons. In the membrane heat treatment, for example, most of the adsorbates of the organic compounds that become the cause of caulking are removed at the intermediate heating temperature, and the remaining adsorbates of the organic compounds and adsorbates such as H₂O that do not become the cause of caulking are removed at the main heating temperature.

As described above, the membrane heat treatment is capable of reducing the occurrence of caulking without increasing the oxygen concentration in the small pores in step S24 (main heating process) and thereby prevents the generation of excessive heat during oxidation of the adsorbates. Accordingly, it is possible to prevent damage to the separation membrane 12. Besides, since the first recovery amount R1 is set to 95% or less of the second recovery amount R2, it is possible to avoid an increase in the intermediate heating time in step S22 and to shorten the time required for the membrane heat treatment. From the viewpoint of efficiently removing the adsorbates while reducing the occurrence of caulking and preventing damage to the separation membrane 12 as described above, the first recovery amount R1 is more preferably 70% or more and 95% or less of the second recovery amount R2.

FIG. 8 is a graph schematically showing how the permeability of the separation membrane 12 is recovered when degradation of the permeability of the separation membrane 12 caused by the adsorption of the adsorbates in the small pores and the membrane heat treatment described above are repeated multiple times. In FIG. 8, a subscript “n” is added to the aforementioned regions 81 to 84, 820, 830, and 840 during the n-th membrane heat treatment. The same applies to the (n+1)th and subsequent membrane heat treatments. In FIG. 8, the membrane heat treatment illustrated on the left side corresponds to the n-th membrane heat treatment, and the membrane heat treatment illustrated on the right side corresponds to the (n+1)th membrane heat treatment. Note that n is an integer greater than or equal to 1 and less than or equal to 2000.

In the following description, the permeability of the separation membrane 12 in the region 840ₙ, in FIG. 8 is referred to as “reference permeability” and given a reference sign Pₙ in FIG. 8. That is, the reference permeability Pₙ refers to the permeability of the separation membrane 12 after n times repetitions of degradation of the permeability of the separation membrane 12 caused by the adsorption of the adsorbates and the membrane heat treatment (steps S21 to S25) described above. In FIG. 8, a reference sign Pₙ₊₁ is assigned to the permeability of the separation membrane 12 in the region 840ₙ₊₁. The permeability Pₙ₊₁ refers to the permeability after the permeability of the separation membrane 12 has degraded again and the membrane heat treatment has been performed once after the measurement of the reference permeability Pₙ. In other words, the permeability Pₙ₊₁ refers to the permeability of the separation membrane 12 after (n+1) times repetitions of degradation of the permeability and the membrane heat treatment.

In the membrane heat treatment, the permeability Pₙ₊₁ is 95% or more of the reference permeability Pₙ. That is, Pₙ₊₁/Pₙ is 95% or higher. This membrane heat treatment allows efficient removal of the adsorbates while reducing the occurrence of caulking as described above. Therefore, even if the membrane heat treatment is repeated multiple times, it is possible to satisfactorily recover and maintain the permeability of the separation membrane 12 at a high level. Note that Pₙ₊₁/Pₙ described above is a value (i.e., performance maintenance rate) that indicates the degree of maintenance of the permeability after the membrane heat treatment has been performed once after the measurement of the reference permeability Pₙ.

Next, the relationship between the post-intermediate-heating recovery rate R1/R2 and the performance maintenance rate in the membrane heat treatment method described above will be described with reference to Table 1 and Table 2.

TABLE 1

| | | | | Post- |
|---|---|---|---|---|
| | | | | Intermediate- |
| | | Performance | Intermediate | Heating |
| | Membrane | Degradation | Heating | Recovery Rate |
| | Type | Conditions | Conditions | R1/R2 |
| Example 1 | DDR | Interior in | 120° C. | 80% |
| | | atmosphere | 8 h | |
| | | two weeks | | |
| Example 2 | DDR | Interior in | 180° C. | 93% |
| | | atmosphere | 4 h | |
| | | two weeks | | |
| Example 3 | DDR | Interior in | 60° C. | 50% |
| | | atmosphere | 12 h | |
| | | two weeks | | |
| Example 4 | DDR | Interior in | 100° C. | 75% |
| | | atmosphere | 6 h | |
| | | two weeks | | |
| Comparative | DDR | Interior in | 55° C. | 45% |
| Example 1 | | atmosphere | 12 h | |
| | | two weeks | | |
| Example 5 | DDR | Interior in | 120° C. | 80% |
| | | atmosphere | 8 h | |
| | | two weeks | | |
| Example 6 | DDR | Interior in | 200° C. | 95% |
| | | atmosphere | 4 h | |
| | | two weeks | | |
| Comparative | DDR | Interior in | — | — |
| Example 2 | | atmosphere | | |
| | | two weeks | | |
| Example 7 | DDR | Exterior in | 120° C. | 77% |
| | | atmosphere | 10 h | |
| | | two weeks | | |

TABLE 2

| | | Performance | Performance | |
|---|---|---|---|---|
| | | Maintenance | Maintenance | |
| | Main | Rate P₂/P₁ | Rate P₁₁/P₁ | |
| | Heating | after 2nd Heat | after 11th Heat | |
| | Conditions | Treatment | Treatment | Evaluation |
| Example 1 | 180° C. | 99% | 96% | ⊚ |
| | 10 h | | | |
| Example 2 | 450° C. | 100% | 99% | ⊚ |
| | 4 h | | | |
| Example 3 | 150° C. | 95% | 88% | ◯ |
| | 12 h | | | |
| Example 4 | 380° C. | 98% | 90% | ⊚ |
| | 5 h | | | |
| Comparative | 180° C. | 92% | 75% | X |
| Example 1 | 10 h | | | |
| Example 5 | 140° C. | 90% | 83% | ◯ |
| | 12 h | | | |
| Example 6 | 380° C. | 98% | 85% | ◯ |
| | 5 h | | | |
| Comparative | 200° C. | 95% | 70% | X |
| Example 2 | 12 h | | | |
| Example 7 | 180° C. | 99% | 94% | ⊚ |
| | 12 h | | | |

In Table 1, “Membrane Type” indicates the type of the zeolite of the separation membrane 12. In the separation membrane complexes 1 according to Examples 1 to 7 and Comparative Examples 1 and 2, the separation membrane 12 is configured by a DDR-type zeolite.

Each separation membrane complex 1 according to Examples 1 to 7 and Comparative Examples 1 and 2 was produced by the following method. First, a monolith alumina support 11 with a diameter of 30 mm and a length of 160 mm was prepared. Then, after 7.329 g of ethylenediamine (produced by Wako Pure Chemical Corporation) was dispensed in a bottle made of fluorocarbon resin, 1.153 g of 1-adamantanamine (produced by Aldrich Co.) was added thereto and dissolved so as not to leave a precipitate of 1-adamantanamine in the bottle. Meanwhile, 115.97 g of water was poured into another bottle, and after 97.55 g of 30% by mass of silica sol (SNOWTEX S produced by Nissan Chemical Corporation) was added thereto and lightly stirred, the aforementioned solution in which 1-adamantanamine was dissolved in ethylenediamine was added thereto and stirred and mixed for approximately one hour until complete dissolution. This produces a starting material solution.

Then, the starting material solution was poured into a pressure-tight vessel that is made of stainless steel and provided with an inner cylinder made of fluorocarbon resin, and the support 11 with DDR-type zeolite seed crystals adhering thereto was immersed in the starting material solution for hydrothermal synthesis. The hydrothermal synthesis was conducted at 120° C. for 84 hours. Accordingly, the separation membrane 12 of the DDR-type zeolite was formed on the inside surfaces of the through holes 111 of the support 11 (see FIG. 1). The support 11 with the separation membrane 12 formed thereon was further rinsed with water and dried. Thereafter, the temperature of the support 11 with the separation membrane 12 formed thereon was raised to 500° C. at a rate of 0.1° C./min in the atmosphere in an electric furnace and then lowered to an ambient temperature at a rate of 0.5° C./min so as to obtain the separation membrane complex 1.

In Table 1, “Performance Degradation Conditions” indicate conditions under which the permeability of the separation membrane 12 was degraded by causing adsorbates to be adsorbed in small pores of the separation membrane 12. In Examples 1 to 6 and Comparative Examples 1 and 2, the permeability of the separation membrane 12 was degraded by leaving the separation membrane complex 1 to stand for two weeks in the atmosphere in the interior. In Example 7, the permeability of the separation membrane 12 was degraded by leaving the separation membrane complex 1 to stand for two weeks in the atmosphere at the exterior. In either case, the permeability of the separation membrane 12 degraded due to the adsorption of substances (e.g., organic compounds or H₂O) in the small pores of the separation membrane 12 in the atmosphere. In this case, the adsorbates substantially contained no sulfur (S) elements. In Examples 1 to 7, the membrane heat treatment (steps S21 to S25) described above was conducted on the separation membrane 12 with degraded permeability by changing the heating conditions (i.e., the heating temperature and the heating time). The same applied to Comparative Examples 1 and 2.

“Intermediate Heating Conditions” indicate the intermediate heating temperature and the intermediate heating time in step S22 (intermediate heating process). “Post-Intermediate-Heating Recovery Rate R1/R2” indicates the aforementioned ratio of the first recovery amount R1 to the second recovery amount R2 (see FIG. 7).

In Table 2, “Main Heating Conditions” indicate the main heating temperature and the main heating time in step S24 (main heating process). “Performance Maintenance Rate P2/P1 after 2nd Heat Treatment” indicates the value obtained by dividing permeability P₂ of the separation membrane 12 by reference permeability P₁. The permeability P₂ refers to the permeability after two repetitions of a series of processing including performance degradation processing and membrane heat treatment on the separation membrane complex 1. The reference permeability P₁ refers to the permeability after one execution of the series of processing including the performance degradation processing and the membrane heat treatment. The permeability was measured by a method similar to the method described with reference to FIG. 7.

“Performance Maintenance Rate P₁₁/P₁ after 11th Heat Treatment” indicates the value obtained by dividing permeability P₁₁ of the separation membrane 12 by the reference permeability P₁. The permeability Pu is the permeability after eleven repetitions of the series of processing including the performance degradation processing and the membrane heat treatment. In “Evaluation of P₁₁/P₁,” the double circle indicates that P₁₁/P₁ is 90% or higher, the single circle “0” indicates that P₁₁/P₁ is higher than or equal to 80% and lower than 90%, and the cross “x” indicates that P₁₁/P₁ is lower than 80%.

In Example 1, the intermediate heating temperature was 120° C., and the intermediate heating time was 8 hours. The post-intermediate-heating recovery rate R1/R2 was 80%. The main heating temperature was 180° C., and the main heating time was 10 hours. The performance maintenance rate P₂/P₁ after the second heat treatment was 99%. The performance maintenance rate P₁₁/P₁ after the 11th heat treatment was 96% (evaluation: the double circle) and high.

In Example 2, the intermediate heating conditions and the main heating conditions were changed from those in Example 1. In Example 2, the intermediate heating temperature was 180° C., and the intermediate heating time was 4 hours. The post-intermediate-heating recovery rate R1/R2 was 93%. The main heating temperature was 450° C., and the main heating time was 4 hours. The performance maintenance rate P₂/P₁ after the second heat treatment was 100%. The performance maintenance rate P₁₁/P₁ after the 11th heat treatment was 99% (evaluation: the double circle) and high.

In Example 3, the intermediate heating conditions and the main heating conditions were changed from those in Example 1. In Example 3, the intermediate heating temperature was 60° C., and the intermediate heating time was 12 hours. The post-intermediate-heating recovery rate R1/R2 was 50%. The main heating temperature was 150° C., and the main heating time was 12 hours The performance maintenance rate P₂/P₁ after the second heat treatment was 95%. The performance maintenance rate P₁₁/P₁ after the 11th heat treatment was 88% (evaluation: o) and relatively high.

In Example 4, the intermediate heating conditions and the main heating conditions were changed from those in Example 1. In Example 4, the intermediate heating temperature was 100° C., and the intermediate heating time was 6 hours. The post-intermediate-heating recovery rate R1/R2 was 75%. The main heating temperature was 380° C., and the main heating time was 5 hours. The performance maintenance rate P₂/P₁ after the second heat treatment was 98%. The performance maintenance rate P₁₁/P₁ after the 11th heat treatment was 90% (evaluation: the double circle) and high.

In Comparative Example 1, the intermediate heating conditions were changed from those in Example 1. In Comparative Example 1, the intermediate heating temperature was 55° C., and the intermediate heating time was 12 hours. The post-intermediate-heating recovery rate R1/R2 was 45% (i.e., less than 50%) and low. The main heating temperature and the main heating time were the same as those in Example 1 and were 180° C. and 10 hours, respectively. The performance maintenance rate P₂/P₁ after the second heat treatment was 92%, but the performance maintenance rate P₁₁/P₁ after the 11th heat treatment was 75% (evaluation: x) and low.

In Example 5, the main heating conditions were changed from those in Example 1. In Example 5, the intermediate heating temperature was 120° C., and the intermediate heating time was 8 hours, as in Example 1. The post-intermediate-heating recovery rate R1/R2 was 80%. The main heating temperature was 140° C., and the main heating time was 12 hours. The performance maintenance rate P₂/P₁ after the second heat treatment was 90%. The performance maintenance rate P₁₁/P₁ after the 11th heat treatment was 83% (evaluation: o) and relatively high.

In Example 6, the intermediate heating conditions were changed from those in Example 4. In Example 6, the intermediate heating temperature was 200° C., and the intermediate heating time was 4 hours. The post-intermediate-heating recovery rate R1/R2 was 95%. The main heating temperature was 380° C., and the main heating time was 5 hours as in Example 4. The performance maintenance rate P₂/P₁ after the second heat treatment was 98%. The performance maintenance rate P₁₁/P₁ after the 11th heat treatment was 85% (evaluation: o) and relatively high.

In Comparative Example 2, step S22 (intermediate heating process) was not performed. Thus, the post-intermediate-heating recovery rate R1/R2 was 0% (i.e., less than 50%). The main heating temperature was 200° C., and the main heating time was 12 hours. The performance maintenance rate P₂/P₁ after the second heat treatment was 95%, but the performance maintenance rate P₁₁/P₁ after the 11th heat treatment was 70% (evaluation: x) and low.

Example 7 was the same as Example 1, except that one performance degradation condition was changed from the interior to the exterior and that the intermediate heating time and the main heating time were made slightly longer. In Example 7, the intermediate heating temperature was 120° C., and the intermediate heating time was 10 hours. The post-intermediate-heating recovery rate R1/R2 was 77%. The main heating temperature was 180° C., and the main heating time was 12 hours. The performance maintenance rate P₂/P₁ after the second heat treatment was 99%. The performance maintenance rate P₁₁/P₁ after the 11th heat treatment was 94% (evaluation: the double circle) and high.

In Examples 1 to 7, since the post-intermediate-heating recovery rates R1/R2 were in the range of 50% to 95%, the performance maintenance rates P₂/P₁ after the second heat treatment were 90% or higher (specifically, in the range of 90% to 100%), and the performance maintenance rates P₁₁/P₁ after the 11th heat treatment were 80% or higher (specifically, in the range of 83% to 99%). In Comparative Example 1, on the other hand, since the post-intermediate-heating recovery rate R1/R2 was 45% (i.e., less than 50%), the performance maintenance rate P₁₁/P₁ after the 11th heat treatment was 75% (i.e., less than 80%) and low. In Comparative Example 2, since the intermediate heating process was not performed and thus the post-intermediate-heating recovery rate R1/R2 was 0% (i.e., less than 50%), the performance maintenance rate P₁₁/P₁ after the 11th heat treatment was 70% (i.e., less than 80%) and low.

A comparison of Examples 1 to 4 and Example 5 shows that, in Examples 1 to 4, since the main heating temperatures were set in the range of 150° C. and 450° C., the performance maintenance rates P₂/P₁ after the second heat treatment was 95% or higher (specifically, in the range of 95% to 100%), and the performance maintenance rates P₁₁/P₁ after the 11th heat treatment was 86% or higher (specifically, in the range of 88% to 99%). In Example 5, on the other hand, since the main heating temperature was set to 140° C. (i.e., lower than 150° C.), the performance maintenance rate P₂/P₁ after the second heat treatment was 90% (i.e., less than 95%) and lower than those in Examples 1 to 4. The performance maintenance rate P₁₁/P₁ after the 11th heat treatment was 83% (i.e., less than 86%) and lower than those in Examples 1 to 4. In Example 5, it is conceivable that the rate of removal of the adsorbates in step S24 (main heating process) was lower than those in Examples 1 to 4 because the main heating temperature was less than 150° C. Accordingly, it is preferable that the main heating temperature is 150° C. or higher and 450° C. or lower.

A comparison of Examples 1 to 4 and Example 6 shows that, in Examples 1 to 4, since the intermediate heating temperatures were set in the range of 60° C. to 180° C., the performance maintenance rates P₂/P₁ after the second heat treatment became 95% or higher (specifically, in the range of 95% to 100%), and the performance maintenance rates P₁₁/P₁ after the 11th heat treatment also became 86% or higher (specifically, in the range of 88% to 99%). In Example 6, on the other hand, since the intermediate heating temperature was 200° C. (i.e., a temperature higher than 180° C.), the performance maintenance rate P₂/P₁ after the second heat treatment was 98% and high, but the performance maintenance rate P₁₁/P₁ after the 11th heat treatment was 85% (i.e., less than 86%) and lower than those in Examples 1 to 4. In Example 6, it is conceivable that, because the intermediate heating temperature was higher than 180° C., the effect of suppressing carbonization of the adsorbates in step S22 (intermediate heating process) was not enough as compared with the effects achieved in Examples 1 to 4, and consequently caulking occurring in step S24 (main heating process) degraded the performance maintenance rate more than in Examples 1 to 4. Accordingly, it is preferable that the intermediate heating temperature is higher than or equal to 60° C. and lower than or equal to 180° C.

A comparison of Examples 1 to 4 shows that the post-intermediate-heating recovery rates R1/R2 were in the range of 80% to 93% in Examples 1 and 2 (i.e., 80% or higher), 75% in Example 4 (i.e., higher than or equal to 70% and lower than 80%), and 50% in Example 3 (i.e., higher than or equal to 50% and lower than 70%). The performance maintenance rates P₂/P₁ after the second heat treatment were in the range of 99% to 100% in Examples 1 and 2, 98% in Example 4, and 95% in Example 3. The performance maintenance rates P₁₁/P₁ after the 11th heat treatment were in the range of 96% to 99% in Examples 1 and 2, 90% in Example 4, and Example 3 in 88%. Accordingly, it is preferable that the post-intermediate-heating recovery rate R1/R2 is 70% or higher and more preferably 80% or higher within the range of 50% to 95%.

A comparison of Examples 1 to 4 shows that the main heating temperatures were in the range of 180° C. to 450° C. in Examples 1, 2, and 4 (i.e., higher than 160° C.) and 150° C. in Example 3 (i.e., lower than 160° C.). The performance maintenance rates P₂/P₁ after the second heat treatment were in the range of 98% to 100% in Examples 1, 2, and 4 and 95% in Example 3. The performance maintenance rates P₁₁/P₁ after the 11th heat treatment were in the range of 90% to 99% in Examples 1, 2, and 4 and 88% in Example 3. Accordingly, it is more preferable that the main heating temperature is 160° C. or higher within the range of 150° C. to 450° C. On the other hand, when the properties of the zeolite membrane 12 such as heat resistance are taken into consideration, the main heating temperature is preferably 400° C. or lower and more preferably 380° C. or lower.

A comparison of Example 1 (performance degradation conditions: interior) and Example 7 (performance degradation conditions: exterior) shows that the post-intermediate-heating recovery rates R1/R2, the performance maintenance rates P₂/P₁ after the second heat treatment, and the performance maintenance rates P₁₁/P₁ after the 11th heat treatment were respectively 80%, 99%, and 96% (evaluation: the double circle) in Example 1 and 77%, 99%, and 94% (evaluation: the double circle) in Example 7. In Example 7, because the degree of performance degradation was considered to be slightly greater than in Example 1, the intermediate heating time and the main heating time were both made longer than in Example 1, but as a result no considerable differences were found in the post-intermediate-heating recovery rate R1/R2, the performance maintenance rate P₂/P₁ after the second heat treatment, and the performance maintenance rate P₁₁/P₁ after the 11th heat treatment. Accordingly, it can be said that differences in performance degradation conditions have not so much influence on the performance maintenance rate in the membrane heat treatment described above.

In Tables 1 and 2, the reference permeability refers to the permeability P₁ of the separation membrane 12 after single execution of degradation of the permeability of the separation membrane 12 caused by the adsorption of the adsorbates and the aforementioned membrane heat treatment (steps S21 to S25), but the reference permeability may be permeability Pₙ of the separation membrane 12 after n times repetitions of degradation of the permeability and the membrane heat treatment, where n is an integer greater than or equal to 1 and less than or equal to 2000. In this case, the performance maintenance rate P₂/P₁ after the second heat treatment corresponds to a performance maintenance rate Pₙ₊₁/Pₙ that represents, by using Pₙ as a reference, permeability Pₙ₊₁ after degradation of the permeability of the separation membrane 12 and the membrane heat treatment were performed once after acquisition of the reference permeability P. The performance maintenance rate P₁₁/P₁ after the 11th heat treatment corresponds to a performance maintenance rate Pₙ₊₁/Pₙ that represents, by using Pₙ as a reference, permeability Pₙ₊₁ of the separation membrane 12 after degradation of the permeability of the separation membrane 12 and the membrane heat treatment were repeated 10 times after the acquisition of the reference permeability P.

In the separation membrane complex 1, even if n varies in the range of 1 to 2000, the performance maintenance rate Pₙ₊₁/Pₙ after the (n+1)th heat treatment was high, i.e., 90% or higher, and the performance maintenance rate Pₙ₊₁/Pₙ after the (n+10)th heat treatment was also high, i.e., 80% or higher, by setting the post-intermediate-heating recovery rate R1/R2 in the range of 50% to 95%. Besides, as can be seen from the comparison of Examples 1 to 4 and Example 5, the performance maintenance rate Pₙ₊₁/Pₙ after the (n+1)th heat treatment is preferably 90% or higher.

The membrane heat treatment described above may be applicable to heat treatment that is performed on membranes other than the separation membrane 12 provided on the support 11. A membrane that can be subjected to the membrane heat treatment may be any permeation membrane that is permeable to high-permeability substances and may, for example, be the separation membrane 12 itself that exists independently of the support 11 or a membrane of a kind that is generally not called a separation membrane.

As described above, the membrane heat treatment method described above is a method of heating a membrane (in the example described above, the separation membrane 12) having small pores with adsorbates adsorbed therein. The membrane heat treatment method includes a process of raising the temperature of the membrane to the intermediate heating temperature (step S21), the process of heating and keeping the membrane at the intermediate heating temperature for a predetermined period of time (step S22), the process of raising the temperature of the membrane to the main heating temperature higher than the intermediate heating temperature (step S23), and the process of heating and keeping the membrane at the main heating temperature for a predetermined period of time (step S24). The first recovery amount R1, which is a difference in the permeability of the membrane between after step S22 and before step S21, is 50% or more and 95% or less of the second recovery amount R2, which is the difference in permeability between after step S24 and before step S21. This reduces the occurrence of caulking due to, for example, carbonization reactions of the adsorbates in the small pores of the membrane. This also avoids an excessive increase in the heat of combustion of the adsorbates in step S24 (main heating process) and thereby prevents damage to the membrane due to a local temperature rise. That is, the membrane heat treatment method described above allows removal of the adsorbates while reducing the occurrence of caulking of the membrane and preventing damage to the membrane.

The method also prevents an excessive increase in the intermediate heating time and thereby avoids an increase in the time required for the membrane heat treatment and allows efficient removal of the adsorbates. Moreover, even if degradation of the permeability of the membrane and the membrane heat treatment are repeatedly performed, it is possible to satisfactorily recover and maintain the permeability of the membrane.

As described above, the permeability (Pₙ₊₁) of the membrane after (n+1) times repetitions of degradation of the permeability of the above membrane and steps S21 to S24 is preferably higher than or equal to 95% of the permeability (Pₙ) of this membrane after n times repetitions of degradation of the permeability of the above membrane and steps S21 to S24 where n is an integer greater than or equal to 1 and less than or equal to 2000. According to the membrane heat treatment method, even if degradation of the permeability of the membrane and the membrane heat treatment are repeatedly performed, it is possible to satisfactorily recover and maintain the permeability of the membrane at a high level.

As described above, the intermediate heating temperature is preferably higher than or equal to 60° C. and lower than or equal to 180° C. In this case, it is possible to satisfactorily reduce, for example, the occurrence of carbonization reactions of the adsorbates adsorbed in the small pores of the membrane in step S22 (intermediate heating process). As a result, it is possible to reduce the occurrence of caulking in the small pores of the membrane and, even if degradation of the permeability of the membrane and the membrane heat treatment are repeatedly performed, it is possible to satisfactorily recover and maintain the permeability of the membrane at a high level.

As described above, the main heating temperature is preferably higher than or equal to 150° C. and lower than or equal to 450° C. This allows satisfactory removal of the adsorbates from the small pores of the membrane in step S24 (main heating process). As a result, it is possible to satisfactorily recover and maintain the permeability of the membrane at a high level, even if degradation of the permeability of the membrane and the membrane heat treatment are repeatedly performed.

As described above, the membrane described above is preferably a zeolite membrane. By composing the membrane of zeolite crystals having uniform molecular sizes, it is possible to satisfactorily achieve selective permeation of a substance targeted for permeation in the process of separating a mixture of substances via the membrane and to efficiently separate the target substance from the mixture of substances.

More preferably, the membrane is composed of a maximum 8-membered ring zeolite. In this case, it is possible to satisfactorily achieve selective permeation of a substance targeted for permeation such as CO₂ that has a relatively small molecular size and to efficiently separate the target substance from a mixture of substances.

The membrane heat treatment method and the separation apparatus 2 described above may be modified in various ways.

For example, the intermediate heating temperature in step S22 may be lower than 60° C., or may be higher than 180° C. The main heating temperature in step S24 may be lower than 150° C., and may be higher than 450° C.

Step S22 (intermediate heating process) described above is not limited to the step of keeping the separation membrane 12 at a single intermediate heating temperature, and as shown in FIG. 9, may be a step of keeping the separation membrane at two-step intermediate heating temperatures tₘ₁ and tₘ₂ for a predetermined period of time. The intermediate heating temperature tₘ₂ is higher than the intermediate heating temperature tₘ₁. As described above, for example, the intermediate heating temperatures tₘ₁ and tₘ₂ may be higher than or equal to 60° C. and lower than or equal to 180° C., preferably higher than or equal to 70° C. and lower than or equal to 160° C., and more preferably higher than or equal to 80° C. and lower than or equal to 150° C. Alternatively, in step S22, the separation membrane 12 may be kept at three-or-more-step intermediate heating temperatures for a predetermined period of time. In these cases, the first recovery amount R1 described above refers to a difference in permeability of the separation membrane 12 between before step S21 and after processing using multiple-step intermediate heating temperatures (i.e., after step S22).

In step S24 (main heating process) as well, the separation membrane 12 may be kept at two-or-more-step main heating temperatures for a predetermined period of time. For example, the two-or-more-step main heating temperatures may be higher than or equal to 150° C. and lower than or equal to 450° C., more preferably higher than or equal to 160° C. and lower than or equal to 400° C., and yet more preferably higher than or equal to 160° C. and lower than or equal to 380° C.

The heating of the separation membrane 12 in steps S21 to S24 does not necessarily have to be performed after detachment of the separation membrane complex 1 from the separation apparatus 2, and these steps may be performed in a state in which the separation membrane complex 1 remains attached to the inside of the outer cylinder 22 of the separation apparatus 2. For example, the separation apparatus 2 may include an approximately tube-like electro thermal heater that comes in contact with the outer peripheral surface of the outer cylinder 22, and the separation membrane 12 may be heated by heating the outer cylinder 22 with the electro thermal heater. Alternatively, the separation membrane 12 may be heated by supplying a heated gas from the supplier 26 to the inside of the outer cylinder 22 and causing the gas to pass through the through holes 111 of the separation membrane complex 1 or to permeate through the separation membrane 12 and the support 11.

The permeability Pₙ₊₁ described above may be less than 95% of the reference permeability Pₙ.

The separation membrane complex 1 may further include, in addition to the support 11 and the separation membrane 12, a functional membrane or a protection membrane that are laminated on the separation membrane 12. Such a functional membrane or a protection membrane may be an inorganic membrane such as a zeolite membrane, a silica membrane, or a carbon membrane, or may be an organic membrane such as a polyimide membrane or a silicone membrane.

As described above, the separation membrane 12 may be an inorganic membrane other than the zeolite membrane, or may be a membrane other than the inorganic membrane (e.g., organic membrane). In the case where the separation membrane 12 is a zeolite membrane, the zeolite membrane 12 may be composed of a maximum 9 or more-membered ring zeolite.

In the separation apparatus 2 described above, substances other than those given in the above description may be separated from a mixed gas. The structure of the separation apparatus 2 is also not limited to the example described above, and may be modified in various ways.

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The present invention is applicable to heating treatment for membranes that are used in, for example, separating any of various fluids.

### REFERENCE SIGNS LIST

12 separation membrane
S11 to S12, S21 to S25 step

1. A membrane heat treatment method for heating a membrane having small pores with adsorbates adsorbed therein, the membrane heat treatment method comprising:
a) raising a temperature of the membrane to an intermediate heating temperature;
b) heating and keeping said membrane at said intermediate heating temperature for a predetermined period of time;
c) raising the temperature of said membrane to a main heating temperature that is higher than said intermediate heating temperature; and
d) heating and keeping said membrane at said main heating temperature for a predetermined period of time,
wherein a first recovery amount that is a difference in permeability of said membrane between after said operation b) and before said operation a) is 50% or more and 95% or less of a second recovery amount that is a difference in permeability of said membrane between after said operation d) and before said operation a).

2. The membrane heat treatment method according to claim 1, wherein
said permeability of said membrane after (n+1) times repetitions of degradation of said permeability of said membrane and said operations a) to d) is 95% or more of said permeability of said membrane after n times repetitions of degradation of said permeability of said membrane and said operations a) to d), where n is an integer greater than or equal to 1 and less than or equal to 2000.

3. The membrane heat treatment method according to claim 1, wherein
said intermediate heating temperature is higher than or equal to 60° C. and lower than or equal to 180° C.

4. The membrane heat treatment method according to claim 1, wherein
said main heating temperature is higher than or equal to 150° C. and lower than or equal to 450° C.

5. The membrane heat treatment method according to claim 1, wherein
said membrane is a zeolite membrane.

6. The membrane heat treatment method according to claim 5, wherein
said zeolite membrane is composed of a maximum 8-membered ring zeolite.
